(19) United States
(12) Patent Application Publication
(10) Pub. No.: US 2025/0333308 A1
(43) Pub. Date: Oct. 30, 2025

(54) APPARATUS AND PROCESS FOR PRODUCTION OF DRY DURABLE CARBON

(71) Applicant: Carbo Culture, Inc., Walnut, CA (US)

(72) Inventors: Christopher Carstens, Hyde Park, NY (US); Douglas P. Dufaux, Orchard Park, NY (US)

(73) Assignee: Carbo Culture, Inc., Walnut, CA (US)

(21) Appl. No.: 18/858,112

(22) PCT Filed: Apr. 17, 2023
(86) PCT No.: PCT/US2023/018825

§ 371 Date: Oct. 18, 2024

Related U.S. Application Data
(60) Provisional application No. 63/332,569, filed on Apr. 19, 2022.

(51) Int. Cl. C01B 32/05; B01J 8/02

(52) U.S. Cl. CPC C01B 32/05; B01J 8/0278; C01P 2006/80

(57) ABSTRACT

A system for producing dry durable carbon from organic material and methods for making and using the same. The system can be configured for initiating a combustion reaction for a feedstock having a first portion being disposed within a zone of reaction of the combustion reaction and a second portion being disposed outside of the zone. A temperature of the combustion reaction can be increased to a predetermined temperature, and a gas pathway can be formed through the zone of reaction for permitting a reactive gas to react with the first portion of the feedstock at the predetermined temperature to produce a first portion of a dry durable carbon product. The system advantageously can enable a feedstock volatile component expelled from the second portion of the feedstock to enter the zone of reaction and react with the reactive gas to form a reacted gas that excludes bio-oil and tar.

### CROSS-REFERENCE TO RELATED APPLICATIONS

This application claims the benefit of, and priority to, U.S. Provisional Application Ser. No. 63/332,569, filed on Apr. 19, 2022, the disclosure of which is hereby incorporated herein by reference in its entirety and for all purposes.

### FIELD

The disclosed embodiments relate generally to the field of carbon production and more particularly, but not exclusively, to methods and apparatuses for production of solid carbon materials from biomass.

### BACKGROUND

A wide variety of processes have been used over many centuries to produce carbonaceous materials, including some that use natural biomass as a feedstock. With recent demand for viable carbon sequestration approaches, a renewed interest in these technologies has appeared.

Systems for converting organic matter into solid carbon forms have been around for centuries. The most well-known method is called pyrolysis where organic (or carbon-containing) matter is heated to elevated temperatures in an inert atmosphere for the purpose of driving off volatile chemicals from the starting feedstock to increase the carbon fraction of the remaining solid feedstock or, in some cases, liquid feedstock. Forcing volatile chemicals from a solid material is early stage of solids combustion and may be called gasification. Pyrolysis has been used in many industrial processes.

Modifications and new systems have evolved from the simple pyrolysis process and include slow pyrolysis, fast pyrolysis, gasification, and carbonization. These systems may use different operating temperatures, gas flow over the feedstock, reactive gases, and other modifications. In recent decades, these systems have considered biomass as feedstock materials. In some instances, the purpose is conversion of a fraction of the carbon contained in the starting biomass into solid carbon, as part of the “green economy.”

Biomass includes any type of plant materials and can be further identified as biomass waste materials, where political and activist will lead carbon capture technology to focus to maintain the living species and take advantage of the already lost living matter. Although any biomass can typically be used in a process, possible after drying, biomass waste is certainly preferred.

Biomass waste includes a wide range of materials, including: (1) agricultural residues such as corncobs, olive pits, walnut shells, sunflower shells and husks, and sugar cane bagasse; (2) wood materials such as wood logs, slabs, chips, and bark; (3) open-water plants such as water hyacinths and seaweed; (4) organic municipal solid wastes, including tires, sewage sludge, or other organic clarified solids; and (5) animal husbandry residues.

The solid carbon materials produced with the various pyrolysis and modified production systems may contain a wide range of carbon, along with ash, moisture, and other materials.

Charcoal is a commonly produced material that has a carbon content of about 70 wt % or more. This material is usually manufactured from hardwoods by pyrolysis in large kilns or retorts at temperatures below about 500° C. Such a material represents a balance between its production costs and the carbon content, as it is used commonly for fuel. Higher processing temperature increases production costs but produces a material with higher carbon fraction. High process temperatures can yield a unique product, in some cases superior to graphite and coal-processed counterparts.

In view of the foregoing, a need exists for a system and method for production of dry durable carbon that overcome the aforementioned obstacles and deficiencies of currently-available pyrolysis systems.

### SUMMARY

The present disclosure relates to systems for producing a solid product can comprise carbon from an organic material and methods for making and using the same. The systems can be configured for converting organic material into carbon can comprise product along with energy.

In accordance with a first aspect disclosed herein, there is set forth a method for producing dry durable carbon, can comprise:
initiating a combustion reaction for a feedstock having a first portion being disposed within a zone of reaction of the combustion reaction and a second portion being disposed outside of the zone of reaction;
increasing a temperature of the combustion reaction to a predetermined reaction temperature;
forming a gas pathway through the zone of reaction for permitting a reactive gas to react with the first portion of the feedstock at the predetermined reaction temperature to produce a first portion of a dry durable carbon product; and/or
enabling a feedstock volatile component expelled from the second portion of the feedstock to enter the zone of reaction and react with the reactive gas to form a reacted gas that excludes bio-oil and tar.

In some embodiments of the disclosed method of the first aspect, the method can further comprise preparing the feedstock for the combustion reaction. The feedstock can be prepared, for example, by drying the feedstock to a predetermined moisture level, sorting the feedstock to achieve a predetermined target packing density and/or disposing the feedstock into a reactor.

The combustion reaction optionally can be initiated by sealing the reactor, igniting the feedstock and/or applying a predetermined reaction pressure to the feedstock. An exemplary predetermined reaction pressure can comprise three hundred and fifty kilopascals.

In some embodiments of the disclosed method of the first aspect, the method can further comprise moving the zone of reaction of the combustion reaction toward the second portion of the feedstock and permitting the reactive gas to react with the second portion of the feedstock at the predetermined reaction temperature to produce a second portion of the dry durable carbon product. Permitting the reactive gas to react with the second portion of the feedstock, for example, can include liberating volatile chemicals from the second portion of the feedstock before moving the zone of reaction of the combustion reaction toward the second portion of the feedstock.

Additionally and/or alternatively, permitting the reactive gas to react with the second portion of the feedstock can include liberating volatile chemicals from the second portion of the feedstock before moving the zone of reaction of the combustion reaction toward the second portion of the feedstock. Liberating the volatile chemicals optionally can comprise liberating a majority of the volatile chemicals from the second portion of the feedstock; whereas, permitting the reactive gas to react with the second portion of the feedstock optionally can comprise subjecting the feedstock in its entirety to the combustion reaction.

In selected embodiments, the method can further comprise terminating the combustion reaction. Terminating the combustion reaction, for example, can include detecting a reduced production of the reacted gas, detecting that the temperature of the combustion reaction is decreasing and/or decreasing a temperature of the feedstock.

In some embodiments of the disclosed method of the first aspect, the method can further comprise forming the reacted gas that excludes the bio-oil and the tar. The forming the reacted gas can comprise partially oxidizing bio-oils and tar produced by the combustion reaction into gaseous components, cracking bio-oils and tar produced by the combustion reaction into lighter hydrocarbons and/or creating precursor sooty materials from bio-oils and tar produced by the combustion reaction. The precursor sooty materials, for example, can form solid sooty particles.

In some embodiments of the disclosed method of the first aspect, the method can further comprise controlling the reaction between the reactive gas and the feedstock. The controlling the reaction, for example, can include controlling the reaction to increase a percentage of carbon in the feedstock that is converted into the dry durable carbon product and/or to decrease an amount of produced liquids in the form of bio-oils and tars.

In some embodiments of the disclosed method of the first aspect, the reactive gas can include oxygen.

In some embodiments of the disclosed method of the first aspect, the method can further comprise harvesting the dry durable carbon product. The harvesting of the dry durable carbon product can include removing the dry durable carbon product from the zone of reaction, storing the harvested dry durable carbon product and/or packaging the harvested dry durable carbon product.

In some embodiments of the disclosed method of the first aspect, the feedstock can comprise a biomass feedstock.

In some embodiments of the disclosed method of the first aspect, the dry durable carbon product can have an oxygen to carbon ratio that is less than five percent.

In some embodiments of the disclosed method of the first aspect, the dry durable carbon product can have a hydrogen to carbon ratio that is less than five percent.

In some embodiments of the disclosed method of the first aspect, increasing the temperature of the combustion reaction can comprise increasing the temperature of the combustion reaction to between five hundred degrees Celsius and seven hundred degrees Celsius.

In accordance with a second aspect disclosed herein, there is set forth a system for producing dry durable carbon, wherein the system can comprise means for carrying out each embodiment of the method of the first aspect. The system, for example, can comprise a double-contained reaction volume for contains the feedstock prior to initiation of the combustion reaction. In selected embodiments, the system can include first containment means with a first housing for defining a first internal chamber for receiving the feedstock and second containment means with a second housing for defining a second internal chamber for receiving the first containment means.

In accordance with a third aspect disclosed herein, there is set forth a computer program for producing dry durable carbon, wherein the computer program product comprises instruction for carrying out each embodiment of the method of the first aspect. The computer program product of the third aspect optionally being encoded on one or more non-transitory machine-readable storage media.

### BRIEF DESCRIPTION OF THE DRAWINGS

For a fuller understanding of the nature and objects of the disclosure, reference should be made to the following detailed description taken in conjunction with the accompanying drawings. These accompanying drawings constitute a part of this specification and illustrate various embodiments, in which:

FIG. 1 is a top-level block diagram illustrating an exemplary embodiment of a reactor for producing dry durable carbon.

FIG. 2 is a top-level block diagram illustrating an exemplary alternative embodiment of the reactor of FIG. 1, wherein the reactor is associated with a system for producing dry durable carbon.

FIG. 3A is a high level flow chart illustrating an exemplary embodiment of a process for producing dry durable carbon.

FIG. 3B is a detail flow chart illustrating an exemplary alternative embodiment of the process of FIG. 3A, wherein the process includes preparing feedstock for reaction.

FIG. 3C is a detail flow chart illustrating another exemplary alternative embodiment of the process of FIG. 3A, wherein the process includes initiating a reaction for the prepared feedstock to generate a dry durable carbon product.

FIG. 3D is a detail flow chart illustrating yet another exemplary alternative embodiment of the process of FIG. 3A, wherein the process includes terminating the reaction for the prepared feedstock.

FIG. 3E is a detail flow chart illustrating still another exemplary alternative embodiment of the process of FIG. 3A, wherein the process includes harvesting the generated dry durable carbon product.

FIG. 4 is a detail drawing illustrating an embodiment of an area around a zone of reaction within the reactor of FIG. 1.

FIG. 5 is a detail drawing illustrating an alternative embodiment of the zone of reaction of FIG. 4.

FIG. 6 is a detail drawing illustrating another alternative embodiment of the zone of reaction of FIG. 4.

FIG. 7 is a high level flow chart illustrating an exemplary alternative embodiment of the process for producing dry durable carbon of FIGS. 3A-E, wherein the process includes disposing feedstock volatile components into the zone of reaction of FIGS. 4-6.

FIG. 8 is a high level flow chart illustrating another exemplary alternative embodiment of the process for producing dry durable carbon of FIGS. 3A-E, wherein the reaction, once initiated, is self-sustaining and maintains the zone of reaction of FIGS. 4-6 at an elevated temperature.

FIG. 9A is a detail drawing illustrating exemplary types of plant matter and other raw materials that can be created by nature and utilized as feedstock by the reactor of FIG. 1.

FIG. 9B is a detail drawing illustrating exemplary types of the dry durable carbon product that can be produced from the plant matter and other raw materials of FIG. 9A.

It should be noted that the figures are not drawn to scale and that elements of similar structures or functions may be generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Since conventional pyrolysis systems cannot produce high-value carbon, are expensive and are compatibility with only limited types of feedstock materials, a system for producing high-value carbon at low cost and using a wide variety of feedstock materials can prove desirable and provide a basis for a wide range of applications, such as production of dry durable carbon.

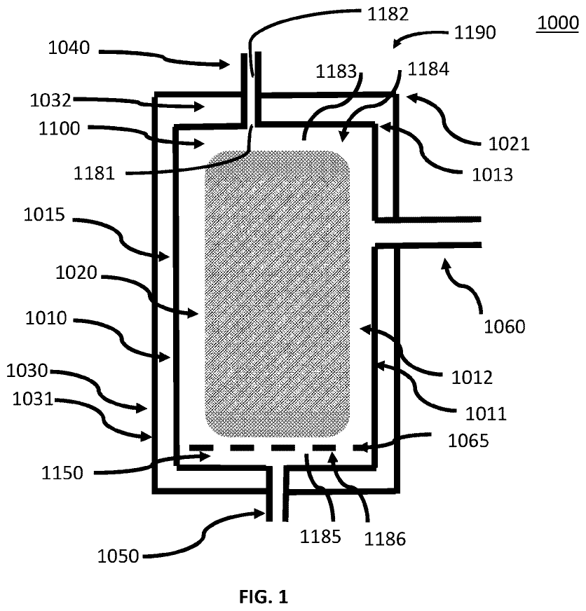

This result can be achieved, according to one embodiment disclosed herein, by a batch style reactor 1000 as illustrated in FIG. 1.

In selected embodiments, the term “dry durable carbon” as used herein can be construed to mean a compound with at least ninety percent carbon content on a dry basis with less than five percent oxygen by weight, and/or less than two percent hydrogen by weight that is produced with a non-water liquid fraction that is less than ten percent by weight of the carbon produced.

The term “non-friable dry durable carbon” as used herein optionally can be construed to mean a dry durable carbon resistant to fracturing into smaller fragments during ordinary handling.

Additionally and/or alternatively, the term “combustion” as used herein can be construed to include “biomass combustion” and/or can comprise an exothermic reaction between oxygen and an organic compound that produces sustained peak temperatures of at least six hundred degrees Celsius at the hottest point of reaction within the feedstock.

In selected embodiments, the term “inert” as used herein can be construed to mean that such compound, composition or material does not react with biomass, or its byproducts of pyrolysis, at temperatures and pressures attained within the reaction container in the practice of the present disclosure.

Referring now to the Figures, FIG. 1 shows an exemplary embodiment of a batch style reactor 1000 for producing dry durable carbon.

The reactor 1000 of FIG. 1 is illustrated as including a first containment vessel 1010 and a second containment vessel 1030. In selected embodiments, the first containment vessel 1010 can comprise a first containment vessel system (or means); whereas, the second containment vessel 1030 can comprise a second containment vessel system (or means). The first containment vessel 1010, for example, can include a first housing 1011 for defining a first internal chamber 1012 into which feedstock 1020 can be disposed and/or held. Additionally and/or alternatively, the second containment vessel 1030 can include a second housing 1031 for defining a second internal chamber 1032. As shown in FIG. 1, the first containment vessel 1010 can be disposed, in whole or in part, within the second internal chamber 1032 defined by the second containment vessel 1030. Stated somewhat differently, the first containment vessel 1010 can be at least partially enclosed by the second housing 1031 of the second containment vessel 1030.

In selected embodiments, the first internal chamber 1012 can be configured to communicate with a reactor operating environment 1190 outside of, or otherwise external to, the reactor 1000. A first housing opening 1181, for example, can be defined by the first housing 1011 and communicate or otherwise cooperate with a second housing opening 1182 defined by second housing 1031. The first internal chamber 1012 thereby can communicate with the reactor operating environment 1190 via the cooperating first and second housing openings 1181, 1182.

Although described as comprising a single first housing opening 1181 and a single second housing opening 1182 for purposes of illustration only, the reactor 1000 can include any predetermined first number of first housing openings 1181 and any predetermined second number of second housing openings 1182, wherein each first housing opening 1181 can communicate or otherwise cooperate with one or more of the second housing openings 1182 and/or each second housing opening 1182 can communicate or otherwise cooperate with one or more of the first housing openings 1181.

The first containment vessel 1010 can be configured for holding the feedstock 1020, including any unreacted feedstock and/or any reacted feedstock, prior to the reaction process. The reactor 1000, in other words, can comprise a double-contained reaction volume for containing the unreacted feedstock mass prior to initiation of a reaction. In selected embodiments, the first containment vessel 1010 can define one or more holes, perforations, ports or other openings (not shown) for allowing gas to escape into the second containment vessel 1030 the first containment vessel 1010 optionally can be rated to hold a predetermined level of pressure. The openings may be defined in predetermined locations of the first containment vessel 1010 to permit the supplied reactive gas to flow in at least one desired pattern. The first containment vessel 1010, for example, can be fabricated from thin metals and be lighter in weight relative to the second containment vessel 1030. In selected embodiments, the first housing 1011 of the first containment vessel 1010 can be formed from a mesh or other porous material.

The reactor 1000 advantageously can be configured to control heat flow within the reactor 1000. As shown in FIG. 1, for example, a heat flow control zone 1015 can be defined between the first containment vessel 1010 and the second containment vessel 1030. In selected embodiments, the heat flow control zone 1015 can be at least partially filled with a gas. Additionally and/or alternatively, the heat flow control zone 1015 may be filled completely or partially with a preselected insulating material.

The heat flow control zone 1015 optionally can be lined with one or more baffles (not shown). The baffles advantageously can be configured to reduce radiation heat transfer from the reaction toward the second containment vessel 1030. In selected embodiments, liquid or gas flow piping (not shown) can be disposed within the heat flow control zone 1015. Hot or cold fluid can flow through the piping to help regulate heat flow between the first containment vessel 1010 and the second containment vessel 1030. Although set forth above as including the heat flow control zone 1015, baffles and/or piping for purposes of illustration only, one or more other suitable devices, such as thermal oil, baffles, and/or other items, can be utilized for controlling the heat flow within the reactor 1000. The suitable devices for controlling the heat flow within the reactor 1000, for example, can be actively or passively temperature controlled, as desired.

In selected embodiments, the reactor 1000 can comprise one or more external ports (not shown). As shown in FIG. 1, exemplary external ports can include, but are not limited to, a gas entry port 1040 defined at an upper region of the reactor 1000, a gas exit port 1050 defined at a lower region of the reactor 1000, and/or one or more utility ports 1060 defined at predetermined locations of the reactor 1000. The number and/or locations of the utility ports 1060 can depend upon a preselected application of the reactor 1000.

An ignition device (or means) 1065 can be disposed at target ignition location within the reactor 1000. In selected embodiments, the ignition device 1065 can be an electrically-operated device. One or more wires for operating the ignition device 1065 can be routed through respective utility ports 1060.

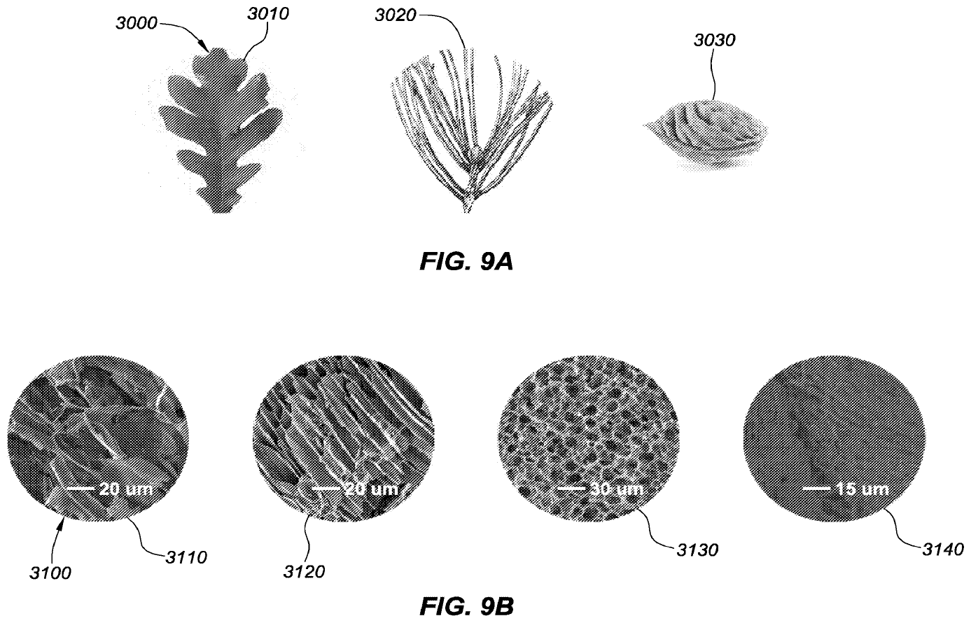

A first containment top (or means) 1013 can be disposed at an upper region of the first containment vessel 1010 and, in selected embodiments, can permit access to the feedstock 1020 or a product, such as a dry durable carbon product 3100 (shown in FIG. 9B), after reaction. The first containment top 1030, for example, can be hinged between an open position for permitting access to the feedstock 1020 or the product after reaction and a closed position for inhibiting access to the feedstock 1020 or the product after reaction. In some embodiments, the first containment top 1013 can be removed, as gas input into the upper region of the reactor 1000 is forced to flow through the feedstock 1020 as the feedstock 1020 is the only available pathway for the inputted gas.

A second containment top (or means) 1021 can be disposed at an upper region of the second containment vessel 1030. The second containment top 1021 can permit access to the first containment vessel 1020 and feedstock 1020 or the product after reaction. In selected embodiments, the second containment top 1021 can be hinged between an open position for permitting access to the feedstock 1020 or the product after reaction and a closed position for inhibiting access to the feedstock 1020 or the product after reaction.

As shown in FIG. 1, an upper plenum 1100 can created in a space 1183 above the feedstock 1020 where gas 1184 can collect prior to flowing into the feedstock 1020. The reactive gases preferably flow uniformly into the feedstock 1020. In selected embodiments, the upper plenum 1100 may include baffles or other features (not shown) for maximizing even distribution of flow of reactive gases into the feedstock 1020. For example, each ten square centimeter area of the feedstock 1020 can receive a proportion of the total area flow rate within thirty percent or, more preferably, within ten percent.

Additionally and/or alternatively, a lower plenum 1150 optionally can be created in a space 1185 below the feedstock 1020 where gas 1186 can collect prior to exiting the reactor 1000 through the gas exit port 1050. In selected embodiments, the lower plenum 1150 can include baffles or other features (not shown) for maximizing even distribution of flow of reactive gases into the feedstock 1020. The baffles or other features optionally can create a back-pressure to help the distribution flow of gases.

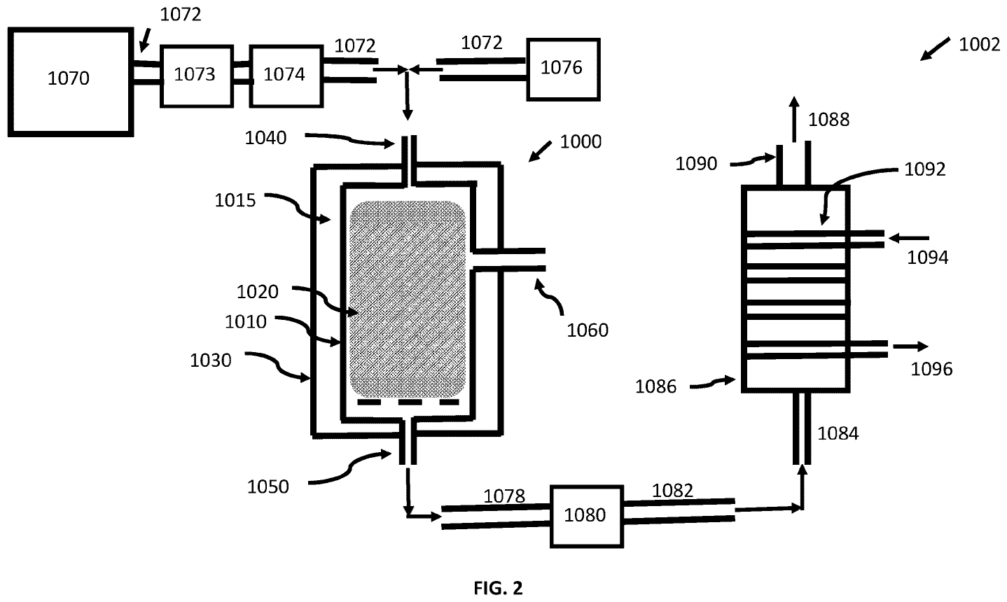

Turning to FIG. 2, the reactor 100 is illustrated as being associated with a system 1002 for producing dry durable carbon. The system 1002, in other words, can include the reactor 1000 as well as additional equipment to support a process for producing dry durable carbon. For example, the additional equipment can provide pressurized (or compressed) air or other reactant gas to the reactor 1000. The system 1002 of FIG. 2 is shown as including an air compressor (or air compression means) 1070 for providing air at elevated pressure. The system 1002 can provide the pressurized air from the air compressor 1070 to the reactor 1000 in any suitable manner. As shown in FIG. 2, the air compressor 1070 can be coupled with the gas entry port 1040 of the reactor 1000 via piping 1072.

The system 1002, for example, can include a flow controller (or flow controller means) 1073 for providing the pressurized air from the air compressor 1070 to the first internal chamber 1012 of the reactor 1000. The flow controller 1073 advantageously can be configured for controlling a flow rate of the pressurized air. Stated somewhat differently, the flow controller 1073 can control a flow rate (or mass flow rate) of the pressurized air to be at predetermined flow rate level and/or can maintain the flow rate within a predetermined range of flow rate levels.

The flow rate through the reactor 1000 can depend upon the cross sectional area of the reactor 1000. In selected embodiments, the flow controller 1073 can control the flow rate of the pressurized air to be between a flow rate range between one kilogram (or cubic meter) of pressurized air or other reactant gas per minute per square meter of feedstock 1020 and twenty-five kilograms of pressurized air per minute per square meter of feedstock 1020 within the reactor 1000. Preferably, the flow rate of the pressurized air can be within a flow rate range between three kilograms of pressurized air per minute per square meter of feedstock 1020 and fifteen kilograms of pressurized air per minute per square meter of feedstock 1020 within the reactor 1000 and, more preferably, within a flow rate range between three and ten kilograms of pressurized air per minute per square meter of feedstock 1020.

In selected embodiments, the flow controller 1073 can include, but is not limited to, a mass flow control device. Exemplary mass flow control devices, for example, can include mass flow controllers available from Aalborg Instruments & Controls, Inc., headquartered in Orangeburg, New York, MKS Instruments, Inc., headquartered in Andover, Massachusetts, Alicat Scientific Inc., headquartered in Tucson, Arizona, and Brooks Instrument, LLC, headquartered in Hatfield, Pennsylvania. The flow controllers 1073 optionally can be based on thermal control technology and/or ultrasonic control technology.

The flow controller 1073 can be separate from, or at least partially integrated with, the air compressor 1070. Stated somewhat differently, the flow controller 1073 may be included as part of the air compressor 1070 and/or the pressurized air can be routed to the flow controller 1073. In selected embodiments, the pressurized air can be routed from the air compressor 1070 to the flow controller 1073 via piping 1072.

In selected embodiments, the system 1002 can be configured to control an air pressure level of the pressurized air to be at predetermined air pressure level and/or can maintain the air pressure level within a predetermined range of air pressure levels. The system 1002, for example, can control the air pressure level of the pressurized air to maintain a pressure range between zero and one thousand, seven hundred and fifty kilopascals (gauge pressure).

Preferably, the air pressure level can be maintained within a pressure range that is between one hundred kilopascals and one thousand kilopascals and, more preferably, within a pressure range that is between one hundred kilopascals and four hundred kilopascals.

The system 1002 optionally can include a pressure regulating device (or means) (not shown) for maintaining or otherwise controlling the air pressure level of the pressurized air. The pressure regulating device can be separate from, or at least partially integrated with, the air compressor 1070. Stated somewhat differently, the pressure regulating device may be included as part of the air compressor 1070 and/or the pressurized air can be routed to the pressure regulating device via, for example, piping 1072.

Additionally and/or alternatively, the air compressor 1070 can provide the pressurized air to the first internal chamber 1012 of the reactor 1000 via a moisture control device (or means) 1074. The moisture control device 1074 can increase and/or decrease an amount of moisture in the pressurized air. In selected embodiments, the moisture control device 1074 can be configured to reduce the fraction of moisture in the pressurized air to a predetermined level. The moisture control device 1074, for example, can reduce the fraction of moisture in the pressurized air to a dew point that is less than twenty degrees Celsius. Preferably, the fraction of moisture in the pressurized air can be reduced to a dew point that is less than zero degrees Celsius and, more preferably, to a dew point that is less than negative forty degrees Celsius. As shown in FIG. 2, the moisture control device 1074 can be coupled with the air compressor 1070 and/or the flow controller 1073 via piping 1072.

The system 1002 optionally can be configured to adjust or otherwise control a chemical composition of the pressurized air. In selected embodiments, the system 1002 can include an oxygen concentrating (or enriching) device (or means) (not shown) for enabling a concentration of oxygen in the pressurized air to be adjusted and/or a nitrogen concentrating device (not shown) for enabling a concentration of nitrogen in the pressurized air to be adjusted. The oxygen concentrating device, for example, can increase and/or decrease the concentration of oxygen in the pressurized air. The oxygen concentrating device can be configured to control the concentration of oxygen in the pressurized air to be at predetermined oxygen concentration level and/or can maintain the concentration of oxygen in the pressurized air within a predetermined range of oxygen concentration levels.

In selected embodiments the oxygen concentrating device can maintain the concentration of oxygen in the pressurized air within a concentration range between five percent and forty percent. Preferably, the concentration of oxygen can be maintained within a concentration range between ten percent and thirty percent and, more preferably, within a concentration range between fifteen percent and twenty-five percent. The percentages can be determined, for example, as a volume fraction of oxygen within the reactant gas stream. The oxygen concentrating device can be separate from, or at least partially integrated with, the air compressor 1070. Stated somewhat differently, the oxygen concentrating device may be included as part of the air compressor 1070 and/or the pressurized air can be routed into and/or out of the oxygen concentrating device via piping 1072.

Additionally and/or alternatively, the nitrogen concentrating device can increase and/or decrease the concentration of nitrogen in the pressurized air. The nitrogen concentrating device can be configured to control the concentration of nitrogen in the pressurized air to be at predetermined nitrogen concentration level and/or can maintain the concentration of nitrogen in the pressurized air within a predetermined range of nitrogen concentration levels.

In selected embodiments the nitrogen concentrating device can maintain the concentration of nitrogen in the pressurized air within a concentration range between zero percent and ninety percent. Preferably, the concentration of nitrogen can be maintained within a concentration range between fifty percent and ninety percent and, more preferably, within a concentration range between seventy percent and ninety percent. The percentages can be determined, for example, as a volume fraction of nitrogen within the reactant gas stream. The nitrogen concentrating device can be separate from, or at least partially integrated with, the air compressor 1070. Stated somewhat differently, the nitrogen concentrating device may be included as part of the air compressor 1070 and/or the pressurized air can be routed into and/or out of the nitrogen concentrating device via piping 1072.

As shown in FIG. 2, the system 1002 optionally can include a store of reaction chemicals 1076. The system 1002 can provide the reaction chemicals 1076 from the store to the reactor 1000 in any suitable manner. The store of reaction chemicals 1076, for example, can be coupled with the gas entry port 1040 of the reactor 1000 via piping 1072 in the manner illustrated in FIG. 2.

The reaction chemicals 1076 can comprise at least one of oxygen, nitrogen, and other reactive or inert gases. In selected embodiments, the reaction chemicals 1076 can include one or more liquids. The reaction chemicals 1076 can be combined with the pressurized air from the air compressor 1070 to form reactive gases. The reactive gases can be provided to the reactor 1000 via the gas entry port 1040.

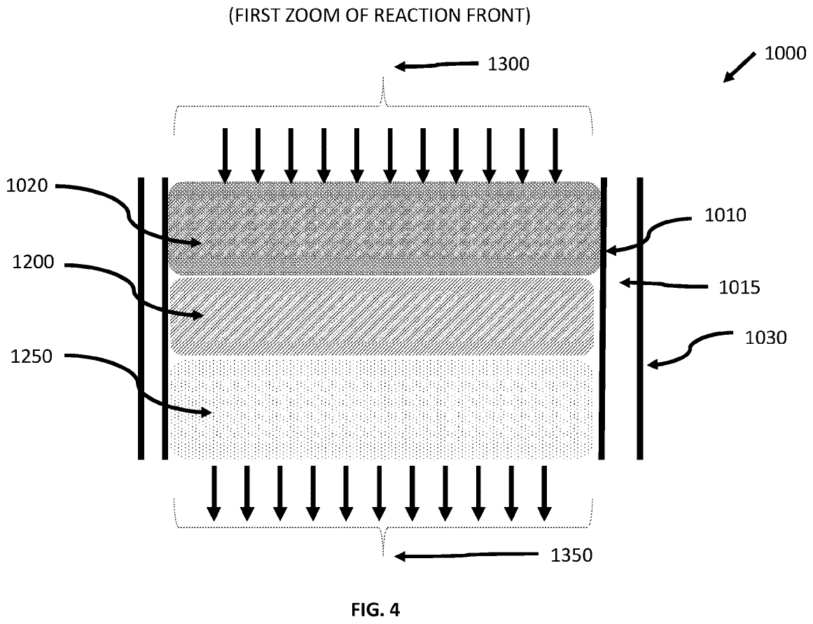

The system 1002 likewise can process gases, such as reacted process gas 1350 (shown in FIG. 4), that can be output from the reactor 1000. As shown in FIG. 2, a pressure control valve (or means) 1080 can be coupled with the gas exit port 1050 of the reactor 1000 for receiving the reacted process gas 1350. The pressure control valve 1080 can be coupled with the gas exit port 1050 via piping 1078. The piping 1078 advantageously can reduce a temperature of the reacted process gas 1350 before the reacted process gas 1350 reaches the pressure control valve 1080. The piping 1078 can reduce a temperature of the reacted process gas 1350 in any suitable manner, such as, via air, water, or other fluid, without limitation. In selected embodiments, the heat removed from the reacted process gas 1350 can be used to generate electricity through a steam generation process.

The reacted process gas 1350 can be provided to a thermal oxidizing unit (or means) 1086 of the system 1002. For example, the reacted process gas 1350 can be provided directly to the thermal oxidizing unit 1086 from the reactor 1000 and/or, as illustrated in FIG. 2, can be provided indirectly to the thermal oxidizing unit 1086 via the pressure control valve 1080. The pressure control valve 1080 and the thermal oxidizing unit 1086 can communicate in any suitable manner, such as via piping 1082. The thermal oxidizing unit 1086 can include an inlet pipe 1084 for receiving the reacted process gas 1350 from the reactor 1000.

The thermal oxidizing unit 1086 can combine the reacted process gas 1350 with oxygen, such as oxygen from air or supplied oxygen, for oxidizing chemicals contained in the reacted process gas 1350. The oxygen can be provided to the thermal oxidizing unit 1086 in any suitable manner. In selected embodiments, the thermal oxidizing unit 1086 can include an air blower (not shown) to provide the air. Additionally and/or alternatively, the air can be supplied via the air compressor 1070 and/or another gas supply system (not shown). After reacting inside of the thermal oxidizing unit 1086, system exhaust gas 1088 can directed to flow into the atmosphere through an exhaust stack 1090.

The thermal oxidizing unit 1086 can enable the reacted process gas 1350 and the oxygen to react. The reaction between the reacted process gas 1350 and the oxygen that occur inside the thermal oxidizing unit 1086 and can release heat, which advantageously can be captured and used to improve energy efficiency of the system 1002. In selected embodiments, the heat can be captured via a heat exchange system 1092 by supplying water at an exchange system inlet 1094 and capturing steam at an exchange system outlet 1096. The thermal oxidizing unit 1086 can utilize any suitable working fluid, such as oil.

Uses for the heated working fluid include drying of biomass, electricity generation, reactor heating, heating of buildings, and/or exported process heat, without limitation. The exported process heat, for example, advantageously used for processes operating adjacent to the system 1002. In selected embodiments, the steam can be routed to a steam generating system (not shown) that produces electricity. Additionally and/or alternatively, the steam may be used directly with a heat exchanger (not sown) to create a heated air stream. The heated air stream may provide heat for local building or other civil uses. The heated air stream may also be used to flow over biomass to reduce its moisture content prior to use.

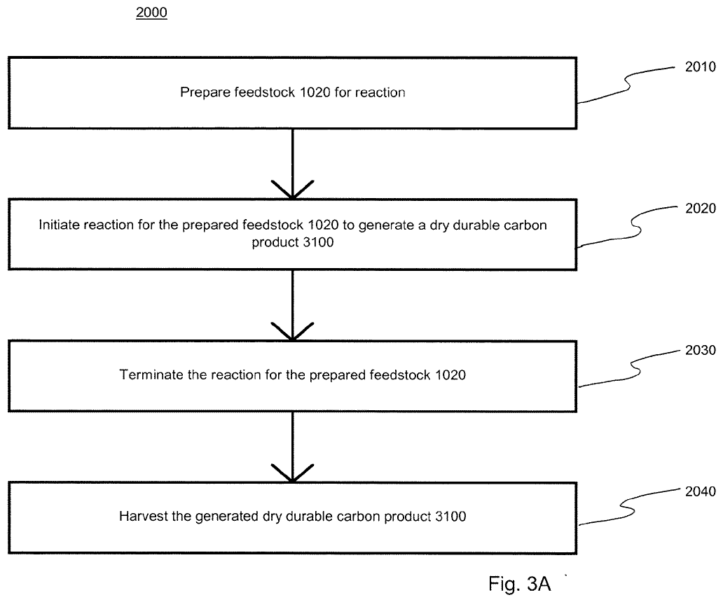

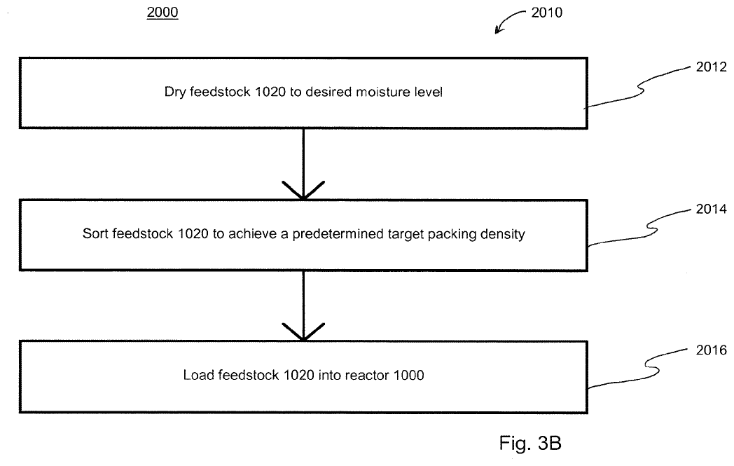

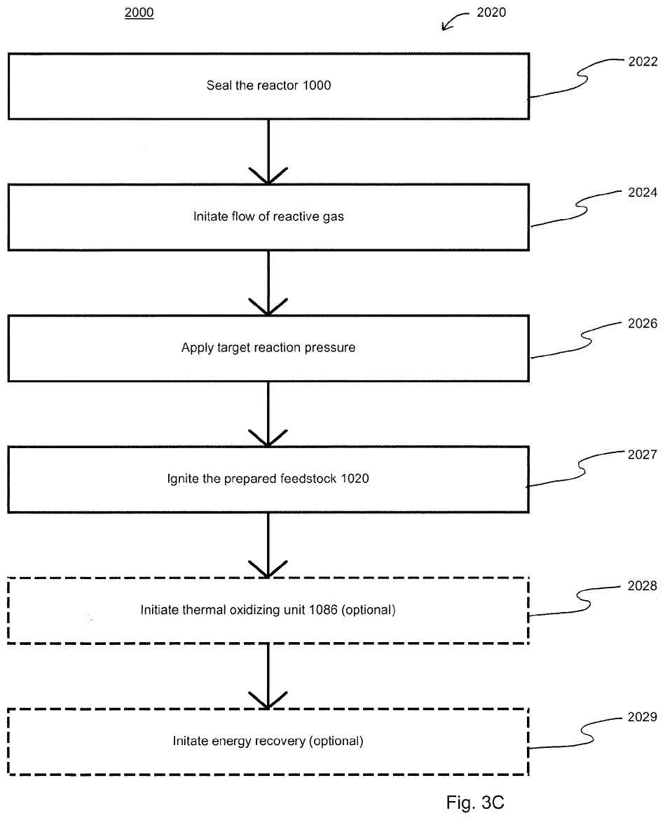

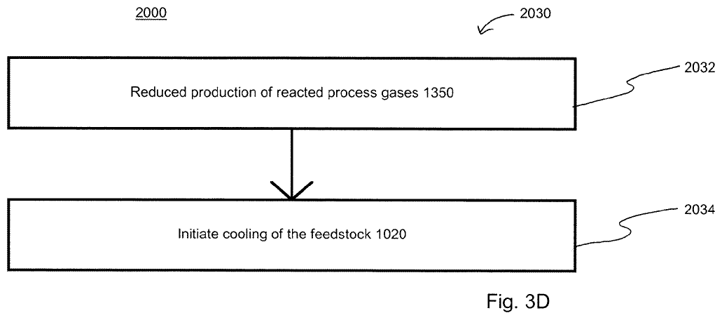

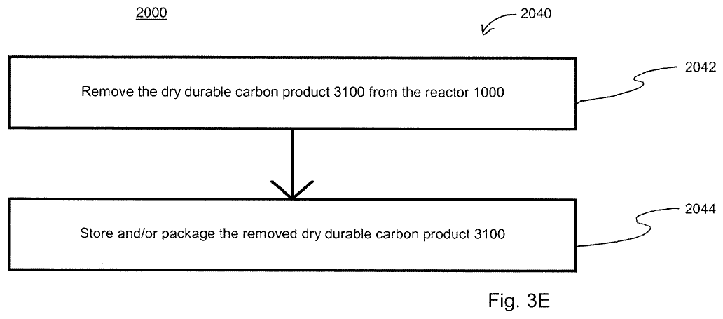

The reactor 1000 and/or the system 1002 can generate the dry durable carbon product 3100 (shown in FIG. 9B) in any suitable manner. An exemplary method 2000 for generating the dry durable carbon product is illustrated in FIG. 3A. In selected embodiments, the method 2000 can be performed via the reactor 1000 (shown in FIGS. 1 and 2) and/or the system 1002 (shown in FIG. 2) to generate the dry durable carbon product 3100 (shown in FIG. 9B).

Turning to FIG. 3A, the method 2000 is shown as including, at 2010, preparing the feedstock 1020 for reaction. A reaction for the prepared feedstock 1020 can be initiated, at 2020, to generate a dry durable carbon product 3100 (shown in FIG. 9B). The reaction can be terminated, at 2030, and the generated dry durable carbon product 3100 can be harvested for use, at 2040.

The feedstock 1020 can be prepared for reaction, at 2010, in any suitable manner. An exemplary manner for preparing the feedstock 1020 for reaction, at 2010, is illustrated in FIG. 3B. Turning to FIG. 3B, the feedstock 1020 can be prepared for reaction by selecting the feedstock 1020 and/or drying the feedstock 1020 to a desired moisture level, at 2012. The moisture content can depend on the feedstock material but, in selected embodiments, is generally below thirty percent moisture on a mass basis. The method 2000 advantageously can utilize a wide variety of feedstocks 1020, including, but not limited to, agricultural residues such as walnut shells, peach and olive pits, tree thinning such as pine pellets and wood shavings, and water-based plants such as water hyacinth.

At 2014, the feedstock 1020 can be sorted to achieve a predetermined target packing density. The feedstock 1020, for example, can be sorted by physical size and characteristics. In selected embodiments, the feedstock 1020 can be sorted to provide a predetermined loaded bulk density.

The feedstock material optionally can be chemically treated. For example, the feedstock 1020 can be sprayed with an iron salt and/or can be submerged into a bath of liquid containing a concentration of iron salt. The treated feedstock 1020 can be dried, and/or iron salt can be dispersed throughout. During the subsequent reaction, the iron salt can react with reactive gases and form metallic iron particles. The iron particles may be useful in environmental remediation applications.

The feedstock 1020 can be loaded into the reactor 1000, at 2016. Stated somewhat differently, the feedstock 1020, at 2016, can be disposed in the first containment vessel 1010 (shown in FIG. 1) of the reactor 1000. The feedstock 1020 can be loaded into the reactor 1000 in any suitable manner. For example, the loading of the feedstock 1020 can comprise opening the upper region and/or a preselected loading port (not shown) of the reactor 1000. The feedstock 1020 can be loaded into the reactor 1000 via an auger, air lifting conveyor or other appropriate lifting system (not shown). In selected embodiments, the first containment vessel 1010 can be removed from the second containment vessel 1030 (shown in FIG. 1) via an overhead crane and loaded externally from the second containment vessel 1030. After loading, the first containment vessel 1010 can be placed back into the second containment vessel 1030.

In a preferred embodiment, load cells (not shown) can be installed on the reactor support legs (not shown) or at the lower region of the reactor 1000 such that a mass of the reactor 1000 can be measured or otherwise determined. The load cells advantageously can be arranged so that the mass can be determined at any time. A volume of the loaded feedstock 1020, for example, can be determined by a height that the feedstock 1020 occupies in the first containment vessel 1010, and the load cells can be used to determine the mass of feedstock 1020 disposed within the first containment 1010.

If the feedstock 1020 has a bulk density that falls within an acceptable range, the reaction can be initiated, at 2020. If the bulk density of the feedstock 1020 is below a lower bulk density limit value, the first containment vessel 1010 and/or the reactor 1000 can be vibrated in an attempt to increase the pack density of the feedstock 1020. Alternatively, the feedstock 1020 can be removed from the reactor 1000 and reloaded into the reactor 1000 if the bulk density of the feedstock 1020 is above an upper bulk density limit value.

The reaction for the prepared feedstock 1020 can be initiated, at 2020, in any suitable manner. An exemplary manner for initiating the reaction for the prepared feedstock 1020, at 2020, is shown in FIG. 3C. Turning to FIG. 3C, the reaction for the prepared feedstock 1020 can be initiated by sealing the reactor 1000, at 2022. In selected embodiments, the reactor 1000, can be sealed, at 2022, by sealing the first containment vessel 1010 and/or sealing the second containment vessel 1030. By sealing the reactor 1000, gas leaks from the reactor 1000 advantageously can be prevented.

In selected embodiments, the reactor 1000 can be sealed such that less than one thousand milliliters per minute leak from the reactor 1000 when the reactor 1000 is pressurized to fifty pounds per square gauge (or PSIG). Preferably, less than five hundred milliliters per minute leak from the reactor 1000 when pressurized to fifty PSIG and, more preferably, less than two hundred milliliters per minute leak from the reactor 1000 when pressurized to fifty PSIG. less than five hundred milliliters per minute leak from the reactor 1000 when pressurized to fifty PSIG.

When the reactor 1000 is sealed, a flow of reactive gas (or a reactive gas mixture) 1300 (shown in FIG. 4) can be initiated, at 2024, within the reactor 1000. A gas pathway can be formed within the reactor 1000 to enable the reactive gas 1300 to contact, and react with, the feedstock 1020. If the reactive gas 1300 is introduced into the reactor 1000 via the gas entry port 1040 (shown in FIG. 1), for example, an exemplary gas pathway can permit the introduced reactive gas 1300 to flow into the upper region of the first containment vessel 1010, through the inside of the first containment vessel 1010, and exit through the lower region of the first containment vessel 1010 into the gas exit port 1050 (shown in FIG. 1). All of introduced reactive gas 1300 thereby can be forced to contact the feedstock 1020. The resultant gas pathway preferably avoids any unintended bypass routes. In some embodiments, the reactive gas 1300 can be sampled through one or more of the utility ports 1060.

The reactor 1000, once sealed, can be pressurized, at 2026. If the reactive gas 1300 is introduced into the reactor 1000 via the gas entry port 1040, for example, the pressure within the reactor 1000 can be increased to a target working (or reaction) pressure. Stated somewhat differently, the target reaction pression can be applied to the reaction 1000.

In selected embodiments, the pressure control valve 1080 (shown in FIG. 1) can be restricted to increase the pressure within the reactor 100 to the desired working pressure; while, the flow rate of the reactive gas 1300 can be fixed at a target rate by the flow controller 1073 (shown in FIG. 1). The mass flow rate of the reactive gas 1300, for example, can be adjusted and/or maintained at a fixed value for the duration of the production process. As the reaction progresses and the reactor 1000, the loaded feedstock 1020 and/or reacted product are heated, the pressure control valve 1080 can automatically actuate for maintaining the reactor 1000 at the target pressure. In some embodiments, the target pressure within the reactor 1000 may change during the reaction. This change in target pressure may be accomplished based upon a pre-programming the pressure control valve 1080 to target a preselected pressure at a predetermined time, based on a location of the reaction front within the feedstock bed, and/or based upon another predetermined triggering condition.

When the flow rate of the reactive gas 1300 and pressure within the reactor 1000 have stabilized to the desired flow rate and working pressure, respectively, the reaction can be initiated. The reaction can be initiated by igniting the feedstock 1020, at 2027. The feedstock 1020, for example, can be ignited via a heated element (not shown).

In selected embodiments, the heated element can comprise an electric ignition coil. The combustion reaction can be initiated by applying a voltage to an electric ignition coil (not shown) to drive electrical current through the ignition coil. The ignition coil, for example, can have an energy density of at least a quarter kilowatts per one hundred square centimeters of feedstock area. Preferably, at least one half of the feedstock area at the ignition location can be exposed to the heated element to help ensure uniform ignition.

The feedstock 1020, in selected embodiments, can be ignited at an end region of the feedstock mass that opposes entry of the reactive gas mixture into the reactor 1000. In a vertically-oriented reactor 1000 where the reactive gas mixture is introduced at the upper region of the reactor 1000, for example, the feedstock mass can be ignited at the bottom region of the reactor 1000.

Once the reaction is initiated, reacted process gases 145 can exit the reactor 1000 via the gas exit port 1050. In certain embodiments, the reacted process gases 1350 can comprise at least one of:
0-60% nitrogen;
10-50% CO₂;
0-50% H₂;
10-50% CO;
0-20% CH₄;
0-5% Ethane;
0-5% Ethylene; and/or
0-5% Heavier hydrocarbons (C3+).

In certain embodiments, the reacted process gases 1350 can comprises less than five percent oxygen. Nitrogen can be included in the reacted process gases 1350 when air or enriched air is used as the reactive gas 1300. The composition of the reacted process gases 1350 can depend on one or more specific characteristics of the feedstock 1020 but generally have a high chemical potential energy. In selected embodiments, the reacted process gases 1350 advantageously can be captured and later used at the reactor 1000 and/or remotely from the system 1002.

In selected embodiments, the method 2000 optionally can include, at 2028, initiating the thermal oxidizing unit 1086 (shown in FIG. 2). The thermal oxidizing unit 1086 can receive gasses, such as the reacted process gases 1350, that exit the reactor 1000 via the gas exit port 1050 and can provide an environment for oxidation of the reacted process gases 1350. The initiated reaction, at 2020, for example, can comprise traditional hydrocarbon combustion where the reacted process gases 1350 combine with oxygen in air to produce primarily carbon dioxide, water, and heat. In selected embodiments, a catalytic bed can be utilized to combine the reacted process gases 1350 and oxygen to produce primarily carbon dioxide, water, and heat. The thermal oxidizer 1086 advantageously can convert potentially undesirable hydrocarbons to safe-to-emit chemicals, such as carbon dioxide and water.

Additionally and/or alternatively, energy recovery optionally can be initiated for the reaction, at 2029. The energy recovery advantageously can include recovery of energy in the form of electricity. If a thermal fluid, such as water, is exposed to the heat generated within the thermal oxidizer 1086, the heated thermal fluid can be utilized to produce an energetic working fluid such as steam. The steam can be used to drive a steam turbine (not shown) that can be configured to generate electricity.

The reaction for the prepared feedstock 1020 can be terminated, at 2030, in any suitable manner. An exemplary manner for terminating the reaction for the prepared feedstock 1020, at 2030, is shown in FIG. 3D. After the reaction has progressed through the entire bed of feedstock 1020, the reacted process gases 1350 can diminish, at 2032, as reactions cease, and/or the temperature of the exiting gases will begin to reduce. After all reaction ceases, the gases will be in the form of reactive gases 1300. In selected embodiments, the end-of-reaction can be determined by monitoring the gas exit temperature and/or the composition of the reacted process gases 1350. At end of reaction, the delivery of oxygen can cease in an effort to preserve solid dry durable carbon product 3100.

At 2034, cooling can be initiated for the feedstock 1020. Cooling the feedstock 1020 advantageously can help preserve as much of the dry durable carbon product 3100 as possible.

Any dry durable carbon product 3100 that is heated above a certain temperature and exposed to air or oxygen can react with the oxygen and reduce the mass of the solid dry durable carbon product 3100. In certain circumstances, run-away reactions may occur as well and could endanger nearby personnel.

In selected embodiments, water can be applied to the dry durable carbon product 3100 in a manner that eliminates or minimizes water in the dry durable carbon product 3100. Water delivered in a liquid form can volatize when contacting the solid dry durable carbon product 3100 at high temperatures. For shipping purposes, it is desirable to minimize an amount of water that is captured in the solid dry durable carbon product 3100. Preferably, less than two hundred grams of added water will be present in each kilogram of the dry durable carbon product 3100 after removal from the reactor 1000. More preferably, less than one hundred grams of added water will be present in each kilogram of the dry durable carbon product 3100 after removal from the reactor 1000. Most preferably, less than fifty grams of added water will be present in each kilogram of the dry durable carbon product 3100 after removal from the reactor 1000.

Preferably, mineral-free water can used to eliminate or minimize an amount of mineral deposits formed on the solid dry durable carbon product 3100 during vaporization. Added water can be defined as a mass of water present in the dry durable carbon product 3100 as compared to the dry durable carbon product 3100 removed without water applied.

The water may be introduced as an aerosol along with nitrogen or other inert gas. Air may be used, in selected embodiments, but use of air risks reaction with hot product that may react and reduce solid mass. For high loadings of water, air is more likely to work without significant loss of solid mass. Additionally and/or alternatively, steam cam be used as a carrier gas, provided the temperature of the reactor 1000 is high enough to allow the steam to remain vaporous. An aerosol nozzle, a nebulizer or other aerosolizing device (not shown) can be used to create water droplets. The aerosolizing device can be used alone or in conjunction with a device (not shown) for directly applying a stream of water to the solid dry durable carbon product 3100.

In selected embodiments, a liquid water delivery device (not shown) can be utilized for delivering water directly onto the solid dry durable carbon product 3100. A pipe (not shown) in the form of a ring may be disposed within the reactor 1000, inside the first containment vessel 1010 and/or second containment vessel 1030 with holes along the ring such that a stream of water cam be sprayed onto the solid dry durable carbon product 3100 and may be used in combination with aerosol water delivery.

Thermal radiation can provide an exemplary mode of heat transfer at the temperatures where the solid carbon risks meaningful oxidation. Once the temperature of the dry durable carbon product 3100 can be reduced below the critical oxidizing temperature, the dry durable carbon product 3100 can be removed in open atmosphere. In selected embodiments, recirculating water can be used to cool the first containment vessel 1010 wall to less than one hundred degrees Celsius to drive the temperature of the dry durable carbon product 3100 lower as heat is transferred from the inside to a wall of the reactor 1000, primarily through radiative heat transfer. A fixed flow rate of water optionally can be used to flow onto an outer wall of the first containment vessel 1010 and a temperature of the water collecting immediately after flowing down the outer wall can be monitored. A temperature increase of the water can be used to estimate the temperature of the dry durable carbon product 3100, the heat transfer rate from the dry durable carbon product 3100 and thus when the dry durable carbon product 3100 can be safely removed from the reactor 1000.

The generated dry durable carbon product 3100 can be harvested, at 2040, in any suitable manner. An exemplary manner for harvesting the generated dry durable carbon product 3100, at 2040, is shown in FIG. 3E. Turning to FIG. 3E, the dry durable carbon product 3100, at 2042, can be unloaded or otherwise removed from the reactor 1000. In selected embodiments, the unloading of the dry durable carbon product 3100 can take place by opening the upper regions of the second containment vessel 1030 and the first containment vessel 1010 and removing the dry durable carbon product 3100 by auger (not shown) and/or air lifting conveyor (not shown).

Additionally and/or alternatively, the dry durable carbon product 3100 can be removed by opening a separate loading port (not shown) of the reactor 1000 and removing the dry durable carbon product 3100 by the auger and/or the air lifting conveyor. In other embodiments, a lower region of the second containment vessel 1030 can be opened (or removed), enabling the dry durable carbon product 3100 to drop out of the reactor 1000 when the lower region of the first containment vessel 1010 is opened. The reactor 1000 thereby can provide direct access and removal of the dry durable carbon product 3100. At 2044, the dry durable carbon product 3100 removed from the reactor 1000 can be stored and/or packaged for shipment.

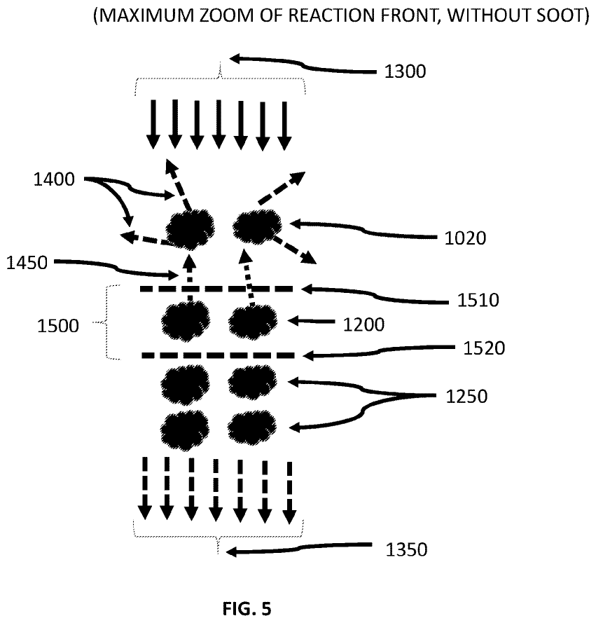

Referring now to FIG. 4, an exemplary schematic representation of a section of feedstock 1020 inside of the reactor 1000 is shown near the plane of reaction. FIG. 4, in other words, illustrates an exemplary area around a zone of reaction 1500 (shown in FIG. 5) within the reactor 1000. If the reactor 1000 comprises a vertical reactor with ignition at the lower region and reactive gases 1300 fed from the upper region, the section of feedstock 1020 can comprise one or more distinct solid materials, including unreacted feedstock 1020, reacting (or reacted) feedstock 1200, and/or first reacted product 1250 as illustrated in FIG. 4. In selected embodiments, the reacted product 1250 can comprise the dry durable carbon product 3100 (shown in FIG. 9B).

Additionally and/or alternatively, if the reactor 1000 comprises a batch style reactor, the zone of reaction 1500 can be at any suitable position along the feedstock 1020 as the reaction moves from the plane of ignition, through the unreacted feedstock 1020, to the end of the feedstock load. In a continuous reactor, the zone of reaction 1500 can be generally fixed in position with the reacting feedstock 1200 being removed on one side and unreacted feedstock 1020 replacing the lost volume on the other size of the zone of reaction 1500, maintaining the zone of reaction 1500 in a fixed location.

The reactive gases 1300 are shown in FIG. 4 as flowing within the reactor 1000 from the upper region of the reactor 1000, over the feedstock 1020, reacting around the zone of reaction 1500, and exiting at the lower region of the reactor 1000 as reacted process gases 1350. The reaction thereby can comprise a multi-step process that can yield the dry durable carbon product 3100 by initially exposing the unreacted feedstock 1020 to high rates of heat transfer leading to high temperatures and liberation of volatile chemical species. In other words, the feedstock 1020 can be exposed to heat, which warms the feedstock 1020 and liberates chemicals, preferably before initiation of the high temperature combustion reaction. As the reaction progresses at a suitable rate, the temperature can increase and liberate additional volatile chemical species.

As the volatile chemicals evolve from the heated feedstock 1020, the volatile chemicals can be carried into the flow of the reactive gas 1300. Upon encountering the high temperature zone and oxygen, the volatile chemicals can react and release heat, continuing the reaction. This mode of operation partially reacts and/or cracks heavy hydrocarbon species, minimizing (or, in selected embodiments, eliminating) production of unwanted liquid fractions, such as oils and tars. The chemistry of reaction, for example, can depend on one or more operating characteristics and/or an amount of oxygen available in the reactive gas 1300.

In selected embodiments, the reaction can comprise a limited-combustion reaction. The limited-combustion reaction can be configured to move from a reaction initiation zone at a lower portion of the feedstock 1020, through a central body of the feedstock 1020, to an upper portion of the feedstock 1020 over a period of time. Advantageously, the limited-combustion reaction may not consume the entire feedstock mass of the feedstock 1020 because the limited-combustion reaction is carried out with a limited amount of oxygen. By limiting the amount of oxygen supplied to the reaction zone, volatile chemicals can be consumed by the limited-combustion reaction while preserving the sought-after carbon fraction.

FIG. 5 is an exemplary schematic representation of individual fragments of reacting and unreacted feedstock within reactor 1000. As illustrated in FIG. 5, the feedstock material can comprise the unreacted feedstock 1020, the reacting feedstock 1200 and/or the primary reacted product 1250. The individual fragments of a section of feedstock 1020 inside the reactor 1000 is shown as being adjacent to the zone of reaction 1500.

In selected embodiments, the zone of reaction 1500 can be defined as the location at which a majority of chemical reaction occurs and/or can be associated with the highest temperature in the reactor 1000. If the reactor 1000 alternatively comprises a cylindrical batch type reactor, for example, the zone of reaction 1500 can form around a plane bounded by an upper reaction plane 1510 and a lower reaction plane 1520. A thickness of the zone of reaction 1500 can be associated with a distance between the upper reaction plane 1510 and the lower reaction plane 1520 and, in selected embodiments, can range from between less the one centimeter to more than ten centimeters depending on the reaction rate of the feedstock 1020, a flow of the reactive gases 1300 and/or a composition of the reactive gases 1300.

As illustrated in FIG. 5, the reactive gases 1300 can enter the zone of reaction 1500 from above the feedstock material 1120, flow within the zone of reaction 1500 and/or over the primary reacted product 1250, and exit below the feedstock material 1120 as reacted process gases 1350. A flow of heat 1450 can be associated with the flow of the reactive gases 1300. The reacted process gases 1350 can be mostly depleted of oxygen since oxygen present in the reactive gases 1300 is consumed during the chemical reactions. Typically, the reacted process gases 1350 can contain energy-rich hydrocarbons and/or carbon monoxide, depending on the specific chemistry of the reaction.

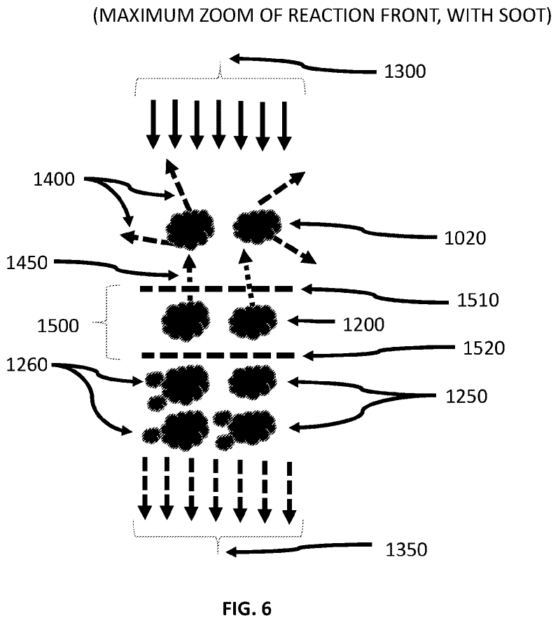

In selected embodiments, the reaction can produce certain hydrocarbons during early stages of heating of the feedstock 1020. While progressing through the reaction zone 1500, the hydrocarbons can form into carbon rich sooty particles 1260. As shown in FIG. 6, the sooty particles 1260 can be deposited onto larger fragments of the primary reacted product 1250. In some embodiments, it can be desirable to separate the sooty particles 1260 from the primary reacted product 1250 because the chemical constitutes of the sooty particles 1260 and the primary reacted product 1250 can be significantly different.

In selected embodiments, one or more separation techniques optionally can be used to separate the sooty particles 1260 from the primary reacted product 1250. Exemplary separation techniques can include mechanical separation techniques, such as a screening technique, a vibratory (or shaking) screening technique, a liquid screening technique and/or an aerosol screening technique, without limitation. The screening technique can involve selecting a screen (not shown) that defines openings with a size, shape or other dimension for allowing the sooty particles 1260 to pass while preventing the primary reacted product 1250 from passing. Stated somewhat differently, the dimension of the openings can be large enough to allow the sooty particles 1260 to pass through the openings but small enough to prevent the primary reacted product 1250 from passing through the openings.

A separation technique that includes shaking or other vibration can help increase a rate at which the sooty particles 1260 are separated from the primary reacted product 1250. Exemplary liquid separation techniques can include, but are not limited to, a floatation separation technique and/or a foaming separation technique. Exemplary aerosol screening techniques can include an aerosol separation technique by particle size through a device (not shown), such as an air classifier, without limitation. The aerosol screening technique can utilize a carrier gas to pass over and/or carry the sooty particles 1260 and the primary reacted product 1250. The sooty particles 1260 can be separated from the primary reacted product 1250 based upon relative sizes and/or relative weights of the sooty particles 1260 and the primary reacted product 1250 via a separation device (not shown), such as a cyclone.

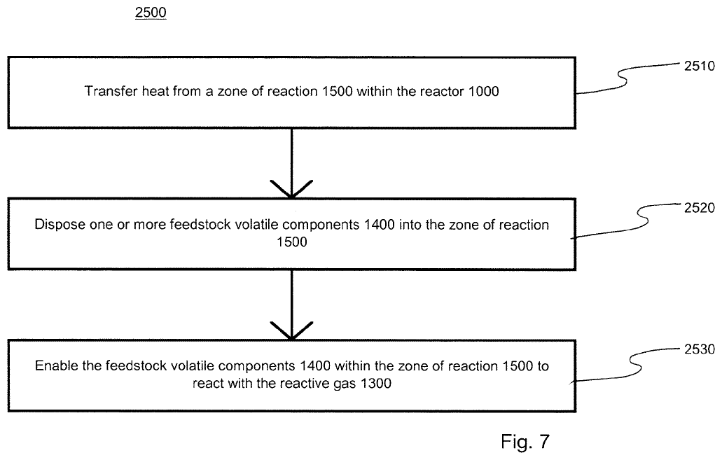

Another exemplary method 2500 for generating the dry durable carbon product is illustrated in FIG. 7. In selected embodiments, the method 2500 can be performed via the reactor 1000 (shown in FIGS. 1 and 2) and/or the system 1002 (shown in FIG. 2) to generate the dry durable carbon product 3100 (shown in FIG. 9B). Turning to FIGS. 5-7, the method 2500 for generating the dry durable carbon product, in selected embodiments, can comprise a multi-step process. The method 2500, at 2510, can include transferring heat from the zone of reaction 1500 with the reactor 1000. The heat transfer, at 2510, for example, can include transferring heat from a high temperature zone of reaction 1500 by radiative heat transfer.

At 2520, one or more feedstock volatile components 1400 can be disposed into the temperature zone of reaction 1500. In other words, a volatile fraction of expelled from the unreacted feedstock 1020 in the form of the feedstock volatile components 1400 and carried into the zone of reaction 1500. The feedstock volatile components 1400 can comprise any predetermined portion of the volatile fraction. In selected embodiments, a majority of the volatile fraction to be expelled from the unreacted feedstock 1020 in the form of the feedstock volatile components 1400 and carried into the zone of reaction 1500.

While within the zone of reaction 1500, the feedstock volatile components 1400 can react with the reactive gas 1300, at 2530. The reaction between the feedstock volatile components 1400 and the reactive gas 1300, in selected embodiments, can create a mixture of components that desirably exclude bio-oils and tars. The mixture of components can exclude the bio-oils and tars in any suitable manner. For example, the mixture of components can exclude the bio-oils and tars by partially oxidizing the bio-oils and tars into gaseous components, by cracking the bio-oils and tars into lighter hydrocarbons and/or by forming or otherwise creating precursor sooty materials from the bio-oils and tars wherein the precursor sooty materials form solid sooty particles 1260.

Historically, bio-oils and bio-tars add significant expense to the cost of operating a biomass processing facility. The method 2500 advantageously can control the reaction between the feedstock volatile components 1400 and the reactive gas 1300. By controlling a reaction between the feedstock 1020 and the reactive gas 1300, such as oxygen, the fraction of carbon converted from the biomass feedstock 1020 into durable carbon can be increased while minimizing an amount of produced liquids in the form of bio-oils and bio-tars. The method 2500 thereby can provide dry durable carbon.

As the reaction continues in the moving zone of reaction 1500, reacting fragments and/or recently-reacted fragments of the feedstock 1020 can transfer heat via, for example, a radiative mechanism and/or conductive mechanism. As the temperature within the zone of reaction 1500 increases, the fraction of heat transfer occurring by radiative processes can continue to increase. The temperature of the unreacted fragments likewise can increase, liberating volatile chemicals. The method 2500 thereby can provide a self-sustaining reaction between the feedstock volatile components 1400 and the reactive gas 1300, which reaction can produce high temperatures and/or move from the plane of ignition through the feedstock 1020 until the feedstock 1020 has been fully consumed.

The method 2500 advantageously can offer several process characteristics. An exemplary process characteristic of the method 2500 can include mass and concentration of the supplied oxygen. In other words, if too much oxygen is supplied, a large fraction of the dry durable carbon product 3100 can be consumed. Another process characteristic of the method 2500 likewise can include control of the flow velocity of reactive gas 1300. If the flow velocity of reactive gas 1300 is too high, convective heat transfer can reduce the heat transfer to the unreacted mass of the feedstock 1020.

Additionally and/or alternatively, a moisture content of the feedstock 1020 control is another process characteristic of the method 2500. Too much moisture in the feedstock 1020, for instance, can lower the rate of reaction and/or can lower the temperature within the zone of reaction 1500. The method 2500 likewise can provide control over an energy content of the feedstock 1020. In other words, the energy content of the feedstock 1020 preferably is sufficiently high to provide energy for the reaction; whereas, a significantly decayed biomass can prevent a successful reaction. In selected embodiments, the method 2500 can provide a suitable packing density for the feedstock 1020 to permit appropriate gas flow rates and/or energy densities.

### Example: Batch, Dry Olive Pits, Counter-Flow Configuration

An exemplary system 1002 (shown in FIG. 1) can include a batch reactor 1000 (shown in FIG. 1) with a thirty-inch diameter first containment vessel 1010 (shown in FIG. 1) and a thirty-six inch diameter second containment vessel 1030 (shown in FIG. 1) can be used to produce dry durable carbon. The first containment vessel 1010 can be removed from the second containment vessel 1030 and loaded with a total of six hundred and ninety kilograms of olive pits with a moisture content of eight and one-half percent After loading, the first containment vessel 1010 can be placed inside the second containment vessel 1030 via an overhead crane, and the lids of the first and second containment vessels 1010, 1030 can be resealed. An insulating gap between the first and second containment vessels 1010, 1030 can comprise a gas pocket for purposes of this example rather than being filled with optional insulating material.

Compressed air can be introduced into the reactor 1000 at 1.13 standard cubic meters per minute. The downstream pressure control valve 1080 (shown in FIG. 1) can be restricted to reach and maintain 415 kPa gauge pressure inside of the second containment vessel 1030; while, the flow rate of compressed air remained constant within +/−0.05 standard cubic meters per minute. The reactor 1000 can be configured to operate in a counter-flow mode with air being fed from the upper region of the reactor 1000 and exiting through the lower region of the reactor 1000 after flowing over the feedstock 1020 (shown in FIG. 1) the comprises a bed of olive pits (not shown). The system 1002 can be configured and tested such that at least ninety-five percent of the flow of gas was through the first containment vessel 1010.

An electric heating coil near the feedstock at the lower region of the first containment vessel 1010 can be energized for five minutes to ignite a combustion reaction between the feedstock 1020 and flowing air. Ignition can be evidenced by a rapid increase in reactor pressure that was relieved by opening the pressure control valve, to maintain pressure at 415+/−15 kPa.

The reaction can be characterized by an exothermic thermal wave that propagates from the lower region of the reactor 1000 to the lower region of the reactor 1000 over a time span of two hundred, eighty-nine minutes. Gases exiting the from the reactor 1000 through the pressure control valve 1080 can be routed into a combustion flare for converting the gasses to safe exhaust gases, comprising, for example, carbon dioxide, water, and nitrogen. The combustion flare can combine the gases exiting the reactor 1000 with air from an electrically-operated blower (not shown) with variable speed. No tars nor bio-oils were observed at any point in the exit flow stream.

After the reaction is completed, the dry durable carbon remained inside of the containment vessels 1010, 1030 for a period of twenty-four hours to allow the dry durable carbon to cool to less than one hundred degrees Celsius. After cooling, the first containment vessel 1010 can be removed from the second containment vessel 1030, and the dry durable carbon can be placed into a storage bin (not shown).

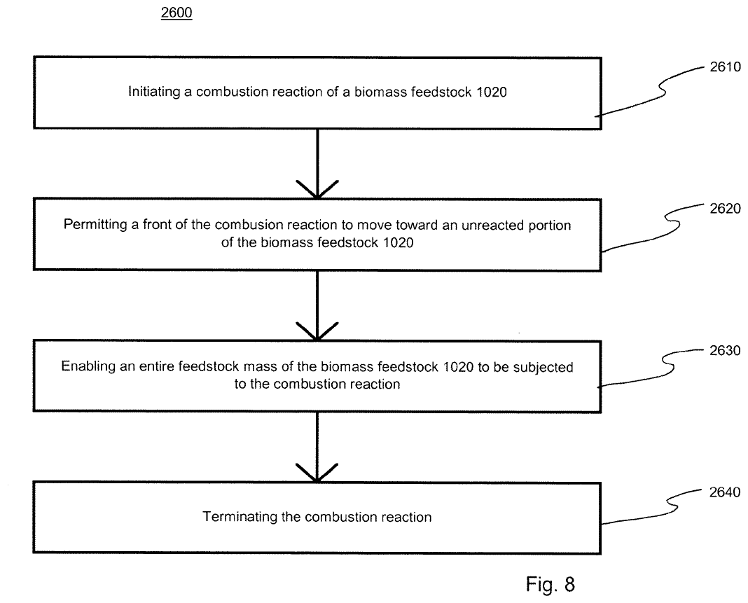

Another exemplary method 2600 for generating the dry durable carbon product is illustrated in FIG. 8. In selected embodiments, the method 2600 can be performed via the reactor 1000 (shown in FIGS. 1 and 2) and/or the system 1002 (shown in FIG. 2) to generate the dry durable carbon product 3100 (shown in FIG. 9B).

The method 2600 advantageously can control a rate of heat loss from the reacting feedstock. In selected embodiments, the rate of heat loss from the reacting feedstock can be adjusted via an equipment configuration of the system 1002. The rate of heat loss, for example, can be defined, at least in part, by providing a feedstock form and packing density within suitable limits inside the reaction volume in the manner discussed herein with reference to the method 2000 of FIGS. 3A-E.

Turning to FIG. 8, the method 2600 can produce the dry durable carbon product 3100 (shown in FIG. 9B), at 2610, by initiating a combustion reaction of a biomass feedstock 1020. The combustion reaction, for example, can be produced by heating the biomass feedstock 1020 in the presence of oxygen to produce the combustion reaction. In selected embodiments, the combustion reaction can be initiated by an external device (or means), such as a high temperature ignition coil, a spark generator, or other combustion-initiating device.

Once the combustion reaction has been initiated, the combustion reaction advantageously can be self-sustaining and/or maintain a high temperature zone while a fraction of the biomass feedstock 1020 and oxygen combine in an exothermic combustion reaction. As a portion of the biomass feedstock 1020 is consumed and becomes reacted feedstock, for example, a combustion front of the combustion reaction can be permitted to move, at 2620, toward a remaining (or unreacted) portion of the biomass feedstock 1020 to continue the combustion process. In other words, the feedstock 1020 can include unreacted feedstock and reacted feedstock, and the combustion front can move from the reacted feedstock toward the unreacted feedstock as the combustion process continues.

The combustion can continue until an entire feedstock mass of the biomass feedstock 1020 has been subjected to the combustion reaction, at 2630. The combustion reaction can terminate, at 2640. In selected embodiments, the combustion reaction can terminate, at 2640, after the entire feedstock mass of the biomass feedstock 1020 has been subjected to the combustion reaction. The mass remaining inside of the reactor 1000 thereby can comprise dry durable carbon, which can be permitted to cool.

In selected embodiments, one or more process conditions preferably are supplied to achieve production of dry durable carbon. A first process condition, for example, can include utilizing a feedstock mass (or biomass) that contains sufficient net chemical energy to sustain a combustion reaction of at least six hundred degrees Celsius. The net chemical energy of the feedstock mass can be impacted by a water (or moisture) content of the feedstock mass. In selected embodiments, the water content of the feedstock mass preferably is kept relatively low.

The water content of the feedstock mass, for example, can be maintained within a moisture range that is less than fifty percent. Preferably, the water content of the feedstock mass can be within a moisture range that is less than twenty-five percent and, more preferably, within a moisture range that is between five percent and fifteen percent.

An exemplary second process condition can comprise configuring the reactor 1000 to limit an amount of heat lost from the hot reaction zone into the environment. In selected embodiments, a double-contained reaction volume, such as the reactor 1000 of FIG. 1 with the first and second containment vessels 1010, 1030, can be used to limit the heat loss. The heat loss advantageously can be reduced by providing a space between the feedstock volume and the environment. The space may comprise an air gap and/or may be filled with one or more insulating materials.

Additionally and/or alternatively, use of a reactor 1000 with an extended diameter can help to minimize the heat loss because the feedstock mass in contact with the perimeter of the reactor 1000 can be reduced as the diameter of the reactor 1000 increases as a function of geometry. The first containment vessel 1010 and the second containment vessel 1030 can have any suitable size, shape, diameter or other dimension. Exemplary dimensions for the first containment vessel 1010 can include a dimension within a dimension range between two feet and ten feet, such as a dimension of three feet, without limitation. The dimensions of the second containment vessel 1030 can be greater than the dimensions of the first containment vessel 1010 and can include, but are not limited to, a dimension within a dimension range between four feet and fifteen feet, such as a dimension of ten feet.

As a third process condition, the combustion reaction preferably can be configured to liberate a majority of the volatile fraction from unreacted biomass prior to entry into the high temperature combustion zone. The majority of the volatile fraction can be liberated, for example, as the combustion reaction transfers heat to the unreacted feedstock, primarily through radiative heat transfer. Once liberated, the volatile chemicals of the volatile fraction can be carried into the combustion zone by the flowing air. The volatile chemicals can react due to the high temperatures within the combustion zone from both pyrolysis and reaction with oxygen. In selected embodiments, the reaction of the volatile chemicals can occur in a counter-flow reactor where oxygen is fed from the an upper region of the counter-flow reactor, and gases produced during the reaction can exit the counter-flow reactor at a lower region of the counter-flow reactor. For example, ignition of the feedstock 1020 can occur at the lower region of the counter-flow reactor and move upwards within the counter-flow reactor until all of the feedstock 1020 has been reacted,

Additionally and/or alternatively, a fourth process condition can include suppling oxygen at a mass flow rate that is sufficient to sustain the combustion reaction with the feedstock while at a flow velocity that is low enough to avoid excessively cooling the combustion reaction and provides sufficient time over the reaction zone. In a preferred embodiment, such a combustion reaction can be accomplished, for example, by increasing an operating pressure of the combustion reaction and/or by increasing a concentration of the oxygen.

### Applications of dry Durable Carbon

Many applications for dry durable carbon exits. In some embodiments, it can be desirable to identify applications that will secure the carbon remains in solid form for extended periods of time, to minimize or eliminate emission of the carbon gaseous form, such as carbon dioxide, as a result of customers or others interest in carbon sequestration.

In selected embodiments, a morphology, including a micro-structure of the raw materials 3000, of the dry durable carbon can influence a performance of the dry durable carbon product 3100. Morphology can be at least partially controlled, for example, by selecting a feedstock material that comprises a micro-structure similar in form to the desired morphology of the dry durable carbon product 3100.

Turning to FIG. 9A, a wide variety of forms (or raw materials) 3000, such as plant matter, that can be created by nature and utilized by the reactor 1000 (shown in FIG. 1) as feedstock 1020 (shown in FIG. 1). Selected raw materials 3000 can include, but are not limited to, one or more oak leaves 3010, one or more pine needles 3020, and/or one or more peach pits 3030. In addition to the variety found in the leaves 3010, needles 3020 (such as pine needles), peach pits 3030 and seeds (not shown) that can be seen by eye, the microstructure comprising many of the raw materials 3000 created by nature can have as much diversity.

In the manner discussed in more detail herein, the reactor 1000 can process the feedstock 1020 to produce the dry durable carbon product 3100. In selected embodiments, the reactor can process feedstock 1020 comprising the raw materials 3000 created by nature to produce the dry durable carbon product 3100. Exemplary dry durable carbon products 3100 produced from the feedstock 1020 comprising the raw materials 3000 created by nature is shown in FIG. 9B. Turning to FIG. 9B, the exemplary dry durable carbon products 3100 can include a first dry durable carbon product 3110 produced from walnut shells, a second dry durable carbon product 3120 produced from beet fiber, a third dry durable carbon product 3130 produced from peach pits 3030 (shown in FIG. 9A), and/or a fourth dry durable carbon product 3140 produced from pine needles or other pine pressings, without limitation.

Depending on the end-use, certain morphologies may be superior. The second dry durable carbon product 3120 produced from the beet fiber feedstock, for example, can be refined to produce a high aspect ratio material with high electrical conductivity.

In selected embodiments, the raw materials 3000 for use as the feedstock 1020 (shown in FIG. 1) and/or the dry durable carbon products 3100 can be refined via a milling process.

In selected embodiments, jet milling can be used alone or in conjunction with ball milling to refine the dry durable carbon product 3100. The jet mill allows grinding of friable materials or crystalline materials to between one and ten microns and, optionally, subsequent classification to a very narrow particle size range at the same time because the friable materials or the crystalline materials can be processed and carried in a gas stream.

The embodiments disclosed herein are not limited to the examples described above and may be used in any combination with each other. Several of the embodiments may be combined together to form a further embodiment. A method or a system, disclosed herein, may comprise at least one of the embodiments described hereinbefore. It will be understood that the benefits and advantages described above may relate to selected embodiments or may relate to several embodiments. The embodiments are not limited to those that solve any or all of the stated problems or those that have any or all of the stated benefits and advantages. It will further be understood that reference to ‘an’ item refers to one or more of that item. The term “comprising” is used in this specification to mean including the feature(s) or act(s) followed thereafter, without excluding the presence of one or more additional features or acts.

In selected embodiments, one or more of the features disclosed herein can be provided as a computer program product. The computer program product, for example, can be encoded on one or more non-transitory machine-readable storage media, such as magnetic, optical and/or electronic storage media of any kind and without limitation. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

1. A method for producing dry durable carbon, comprising:
initiating a combustion reaction for a feedstock having a first portion being disposed within a zone of reaction of the combustion reaction and a second portion being disposed outside of the zone of reaction;
increasing a temperature of the combustion reaction to a predetermined reaction temperature;
forming a gas pathway through the zone of reaction for permitting a reactive gas to react with the first portion of the feedstock at the predetermined reaction temperature to produce a first portion of a dry durable carbon product; and
enabling a feedstock volatile component expelled from the second portion of the feedstock to enter the zone of reaction and react with the reactive gas to form a reacted gas that excludes bio-oil and tar.

2. The method of claim 1, further comprising preparing the feedstock for the combustion reaction, wherein said preparing the feedstock includes sorting the feedstock to achieve a predetermined target packing density.

3. (canceled)

4. (canceled)

5. (canceled)

6. The method of claim 1, wherein said initiating the combustion reaction includes sealing a reactor and igniting the feedstock.

7. The method of claim 6, wherein said initiating the combustion reaction includes applying a predetermined reaction pressure to the feedstock.

8. (canceled)

9. The method of claim 1, further comprising moving the zone of reaction of the combustion reaction toward the second portion of the feedstock and permitting the reactive gas to react with the second portion of the feedstock at the predetermined reaction temperature to produce a second portion of the dry durable carbon product.

10. The method of claim 9, wherein said permitting the reactive gas to react with the second portion of the feedstock includes liberating volatile chemicals from the second portion of the feedstock before moving the zone of reaction of the combustion reaction toward the second portion of the feedstock.

11. The method of claim 10, wherein said liberating the volatile chemicals comprises liberating a majority of the volatile chemicals from the second portion of the feedstock.

12. The method of claim 9, wherein said permitting the reactive gas to react with the second portion of the feedstock comprises subjecting the feedstock in its entirety to the combustion reaction.

13. (canceled)

14. (canceled)

15. (canceled)

16. (canceled)

17. The method of claim 1, further comprising forming the reacted gas that excludes the bio-oil and the tar.

18. The method of claim 17, wherein said forming the reacted gas comprises partially oxidizing bio-oils and tar produced by the combustion reaction into gaseous components,

19. The method of claim 17, wherein said forming the reacted gas comprises cracking bio-oils and tar produced by the combustion reaction into lighter hydrocarbons.

20. The method of claim 17, wherein said forming the reacted gas comprises creating precursor sooty materials from bio-oils and tar produced by the combustion reaction.

21. (canceled)

22. The method of claim 1, further comprising controlling the reaction between the reactive gas and the feedstock.

23. The method of claim 22, wherein said controlling the reaction increases a percentage of carbon in the feedstock that is converted into the dry durable carbon product.

24. The method of claim 22, wherein said controlling the reaction decreases an amount of produced liquids in the form of bio-oils and tars.

25. The method of claim 1, wherein the reactive gas includes oxygen.

26. (canceled)

27. (canceled)

28. (canceled)

29. (canceled)

30. The method of claim 1, wherein the feedstock comprises a biomass feedstock.

31. The method of claim 30, wherein the dry durable carbon product has an oxygen to carbon ratio that is less than five percent.

32. The method of claim 30, wherein the dry durable carbon product has a hydrogen to carbon ratio that is less than five percent.

33. (canceled)

34. A system for producing dry durable carbon, the system comprising means for carrying out the method of claim 1.

35. (canceled)

36. The system of claim 34, wherein the system includes first containment means with a first housing for defining a first internal chamber for receiving the feedstock and second containment means with a second housing for defining a second internal chamber for receiving said first containment means.

37. A computer program product for producing dry durable carbon, the computer program product comprising instruction for carrying out the method of claim 1.

38. The computer program product of claim 37, wherein the computer program product is encoded on one or more non-transitory machine-readable storage media.
